(19) United States
(12) Patent Application Publication
(10) Pub. No.: US 2007/0178374 A1
(43) Pub. Date: Aug. 2, 2007

(54) Multi-layered apparatus for stopping projectiles

(75) Inventors: Joanna Aizenberg, New Providence, NJ (US); Elsa Reichmanis, Westfield, NJ (US); Oleksander Sydorenko, Piscataway, NJ (US); Brijesh Vyas, Warren, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 11/344,718

(22) Filed: Feb. 1, 2006

(51) Int. Cl. H01M 2/16; B32B 27/12

(52) U.S. Cl. 429/144; 429/127; 442/43

(57) ABSTRACT

An apparatus comprising a stack of layers, each of the layers having one or two surfaces that contact neighboring ones of the layers. At least one of the layers comprises a mesh layer, and, a shear thickening fluid is located within the mesh layer or in another layer of the stack of layers.

### TECHNICAL FIELD OF THE INVENTION

The present invention relates an apparatus having layered materials that are capable of stopping projectiles, and a method of making the apparatus.

### BACKGROUND OF THE INVENTION

There is growing interest in the use of wearable articles that can provide a source of power to operate electrical devices. There are substantial challenges, however, to developing such articles that also can withstand harsh environments, such as encountered in military applications. It is desirable therefore to incorporate armor into the wearable article to protect the battery. Unfortunately, both conventional batteries and body armor are heavy and bulky. This, in turn, may require a limitation to one or more of the extent of armor, the capacity of the battery, or the conditions and environment under which personnel can wear such articles.

### SUMMARY OF THE INVENTION

One embodiment is an apparatus comprising a stack of layers, each of the layers having one or two surfaces that contact neighboring ones of the layers. At least one of the layers comprises a mesh layer. A shear thickening fluid is located within the mesh layer or in another layer of the stack of layers.

Another embodiment is a method manufacturing an apparatus. The method comprises forming a stack of layers, each of the layers having one or two surfaces that contact neighboring ones of the layers. At least one of the layers comprises a mesh layer, and a shear thickening fluid is located within the mesh layer or in another layer of the stack of layers.

### BRIEF DESCRIPTION OF THE DRAWINGS

The invention is best understood from the following detailed description, when read with the accompanying FIGUREs. Various features may not be drawn to scale and may be arbitrarily increased or reduced in size for clarity of discussion. Reference is now made to the following descriptions taken in conjunction with the accompanying drawings, in which:

FIG. 1 illustrates a cross-sectional view of an exemplary apparatus;

FIGS. 2A and 2B show plan views of different embodiments of a mesh layer of the apparatus presented in FIG. 1;

FIG. 3 presents a flow diagram showing selected steps in an exemplary method of manufacture;

### DETAILED DESCRIPTION

The present invention benefits from biommetic studies of sea sponges. Sea sponges have skeletal structures composed of uniform mesh-like structures that afford them very high strength. It was discovered that the strength of sea sponge skeletal structures derives from a hierarchical assembly of components ranging in size from microscopic to macroscopic. It is thought that the combination of nanometer or micrometer-sized particles embedded inside of layers located between or within the mesh-like structures, and the use of multiple layers are important to providing strength. Moreover, at least some of the layers in the skeletal structures can perform other functions in the organism.

These insights lead to the realization that a multilayered wearable article that incorporates particles in a shear thickening fluid and that has one or more mesh layers could provide an effective protective barrier against projectile penetration. Additionally, in some cases, at least some of the layers can have other functions, such as a battery function. Moreover, incorporating multi-functionality into one or more of the multiple layers advantageously reduces the article's weight or bulkiness.

One embodiment is an apparatus. In some preferred embodiments, the apparatus comprises a multilayered wearable article, such as a bullet-proof vest, that incorporates a battery. In other cases, however, the apparatus can be a non-wearable article, such as a battery shielding or computer cover. In some embodiment, at least some of the layers can provide a dual functionality of protecting against projectile penetration and serving as a battery component.

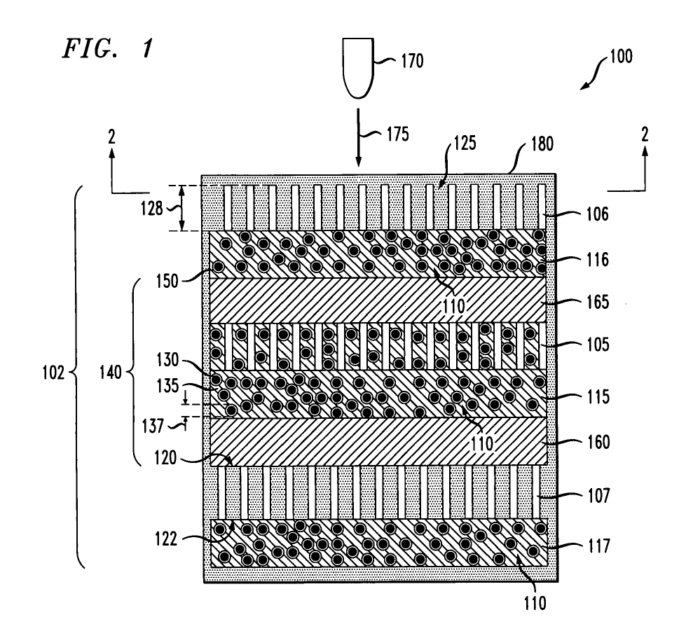

FIG. 1 presents a cross-sectional view of an exemplary apparatus 100. The apparatus comprises a stack of layers 102. It is critical to have multiple layers 102 in order to provide the protective functionality of preventing projectile penetration. At least one of the layers comprises a mesh layer 105. At least one of the layers comprises a shear thickening fluid 110. In some cases, as shown in FIG. 1, there can be a plurality of mesh layers 105, 106, 107. The shear thickening fluid 110 can be located within one or more mesh layers (e.g., layer 105 in FIG. 1), or in another layer of the stack of layers 102. As also illustrated for the apparatus shown in FIG. 1, a plurality of layers 115, 116, 117 can comprise the shear thickening fluid 110. Each layer in the stack of layers 102 has one or two surfaces that contact neighboring ones of the layers 102. For example, mesh layer 107 shown in FIG. 1 has two surfaces 120, 122 that contact neighboring layers 117, 160.

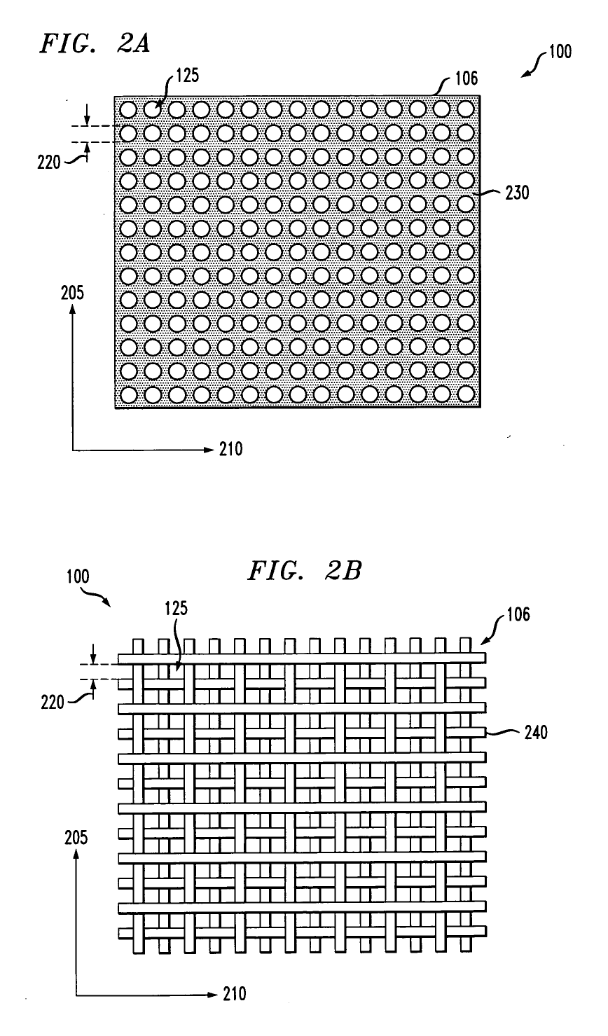

FIGS. 2A and 2B present a plan view through view line 2-2 of the apparatus 100 depicted in FIG. 1, to illustrate two possible embodiments of exemplary mesh layer 106. For clarity, other components of the apparatus 100 are not shown. The term mesh layer as used herein refers to a sheet, film or fabric having pores or openings. For example, the mesh layer 106, such as shown in FIGS. 1, 2A and 2B has one small dimension, corresponding to the mesh layer's thickness 128 (FIG. 1) and two larger dimensions 205, 210. The mesh layer can have a plurality of openings 125 (FIG. 2A or 2B). Each of the openings 125 have at least one dimension 220 in the plane of the two larger dimensions 205, 210. The openings 125 are preferably less than about 1000 microns. In some cases, for example, when the opening 125 is circularly shaped, the opening's diameter 220 is less than about 1000 microns.

In some instances, the mesh layer can comprise a continuous sheet or film of material having openings there-through. For example, the mesh layer 106, such as shown in FIG. 2A, can comprise a sheet 230 made out of a polymer or composition material through which the openings 125 are made. Alternatively, the mesh layer 106, such as shown in FIG. 2A, can comprise polymer or composite materials solidified from precursors placed in a mold with raised structures corresponding in size to the openings 125. In still other cases, such as shown in FIG. 2B, the mesh layer 106 can comprise a fabric woven from fibers 240 of a polymer or composite material.

The mesh layer can be composed of any strong material that promotes protection against projectile penetration into the apparatus. It is advantageous for the mesh layer to be composed of a material that is insoluble in, and non-reactive with, the shear thickening fluid. In cases where the apparatus is an article of clothing, it is also desirable for the mesh layer to be flexible enough to permit body movement while wearing the apparatus. In some cases, the mesh layer comprises a polymer such as a trans-polyamide like polyparaphenylene terephthalamide (e.g., KEVLAR®). In other instances, the mesh layer comprises a composite material (e.g., fiberglass) comprising an epoxy resin (e.g., polyester) and glass fibers.

In some preferred embodiments, the material of the mesh layer is anisotropic. The term anisotropic material, as used herein, refers to a material that has greater projectile penetration stopping ability in one direction than in another direction. In some instances, the mesh layer is composed of polymer fibers that are oriented in a particular direction to. facilitate the alteration of the projectile's path. For example, a polymer comprising KEVLAR® can be oriented in a particular direction by rapid prototyping, ink-jetting, electrospinning or subjecting to external fields or shear stresses.

The term shear thickening fluid, as used herein, refers to a composition whose viscosity increases when subjected to a high shear rate. In some preferred embodiments, the viscosity of the shear thickening fluid increases in the range from several times to several orders of magnitude, when subjected to a shear rate ranging from 10¹ to 10³ s⁻¹. In other preferred embodiments the viscosity increase ranges from two to three orders of magnitude. It is desirable to use shear thickening fluids in the stack of layers 102 that remain flexible until it is subjected to high shear. This property is conducive to embodiments of the apparatus that are an article of clothing.

As illustrated in FIG. 1, some embodiments of the shear thickening fluid 110 comprise particles 130 suspended in a fluid 135. In certain embodiments, the shear thickening fluid 110 includes at least about 50 percent by weight particles 130. In some cases, it is desirable for the particle 130 to have sizes that are substantially similar to the size of the openings 125, so that the particles 130 can impregnate into and be held by the mesh layer 105. In some preferred embodiments, for instance, the particles 130 of the shear thickening fluid 110 have an average diameter 137 that is within about 20 percent of the one dimension 220 (e.g., average diameter) of the openings 125 (FIG. 2A or 2B) in the mesh layer 105.

The particles 130 can be nanoparticles, having an average diameter 137 ranging from about 1 to about 1000 nanometers, or microparticles, having an average diameter 137 ranging from about 1 to about 1000 microns. Examples of suitable materials for the particles 130 include inorganic materials such as silica or titania. As an example, the shear thickening fluid 110 can comprise silica particles 130 suspended in a fluid 135 of ethylene glycol, the particles 130 having an average diameter 137 of about 450 nanometers.

The shear thickening fluid 110 can also comprise a polymer. In some cases the polymer is a hydrophobic polymer, that is, a polymer having one or more hydrophobic substituants. Examples of suitable hydrophobic polymers include polyethylene glycol or polypropylene glycol polymers that are substituted with hydrophobic groups, such as alkyl groups (e.g., octyl, trimethyl or octadecyl groups). Other examples include polyacrylamides that are substituted with hydrophobic groups such as an isopropyl group, forming, e.g., a poly(N-isopropylacrylamide). Still other examples include polystyrene, poly(methylmethacrylate) or polytetrafluoroethylene (e.g., TEFLON®).

The inclusion of hydrophobic polymers can be advantageous when the shear thickening fluid 110 is also an electrolyte, and more preferably, comprises electrolytes of a battery 140. The high ionic strength of electrolytes used in battery applications may disrupt the hydrogen bonds and electrostatic interactions that allow certain shear thickening fluids to harden when subject to a high shear rate. However, shear thickening due to hydrophobic interactions due, e.g., to the presence of hydrophobic polymers in the shear thickening fluid, 110 is not believed to be affected by high ionic strengths.

In some instances, the particles 130 are physically or chemically modified with a polymer, and more preferably, a hydrophobic polymer. As illustrated in FIG. 1, in some cases a polymer coating 150 surrounds the particles 130. Coating the particles 135 with a polymer is desirable because this promotes hydrophobic interactions conducive to shear thickening. Also, the hydrophobic polymer coating allows fine-tuning of viscous characteristics of the shear thickening fluid, such as critical stress value and viscosity at lower and higher stresses.

As noted above, in some cases, the shear thickening fluid 110 is the electrolyte for a battery 140 of the apparatus 100. In such cases one or more of the layers (e.g., layers 105, 115 in FIG. 1) comprising the shear thickening fluid 110 are electrolyte layers. In other cases, however, one or more of the layers in the stack of layers 102 can comprise an electrolyte layer composed of material that is not shear thickening. It can be advantageous for the electrolyte layer to comprise the mesh layer (e.g., layer 105) so as to provide further protection against projectile penetration.

The term electrolyte as used herein refers to a composition that can provide ion conductivity for a battery. The electrolyte of the shear thickening fluid 110 or the electrolyte layer can include salts, bases or acids, such as lithium hexaflourophosphate, potassium hydroxide or sulfuric acid, or polymers, such as polyacrylonitrile, polymethylmethacrylate, or polyethylene oxide.

In still other embodiments, the stack of layers 102 further includes a negative electrode 160 and positive electrode 165 of the battery 140. The layer or layers that contain the electrolyte (e.g., layers 105, 115 in FIG. 1) are preferably located between the negative and positive electrodes 160, 165. Each of the negative and positive electrodes 160, 165 contact one of the two surfaces of the electrolyte layer. The negative and positive electrodes 160, 165 can be made of any conventional electrically conductive material suitable for battery applications. In some cases, for example, the negative electrode 160 comprises lead, the positive electrode 165 comprises lead oxide, and the electrolyte comprises sulfuric acid, thereby forming a lead acid battery 140.

As further illustrated in FIG. 1, in some cases, the stack of layers 102 is able to dissipate the energy of a projectile 170 contacting the stack of layers 102. The projectile 170, for example, can be a bullet fired at the apparatus 100, shrapnel resulting from an explosion near the apparatus 100, or particulate matter in the air, such as sand, that the apparatus 100 is traveling through, or that is traveling towards apparatus 100. The stack of layers 102 can be configured, for example, to stop the penetration of a projectile 170 through the full thickness of the layers 102, and in some cases, stop the penetration through the layers that form the battery 140. In some embodiments, the stack of layers 102 is configured to deviate or divert the projectile's 170 path 175, and thus reduce penetration in the direction of the battery or wear's body, which is the direction perpendicular to the layers. In some preferred embodiments, the projectile's deviation or diversion is facilitated by the presence of anisotropic materials in one or more of layers in the stack of layers 102.

In some cases the apparatus 100 is packaged so that the stack of layers 102 and battery 140, when present, are held together. For example, a covering 180 composed of a polymer such as polypropylene or polyethylene can surround the outer surface of the apparatus 100. Similar coverings can be used to facilitate containment of the shear thickening fluid 110 in the stack of layers 102.

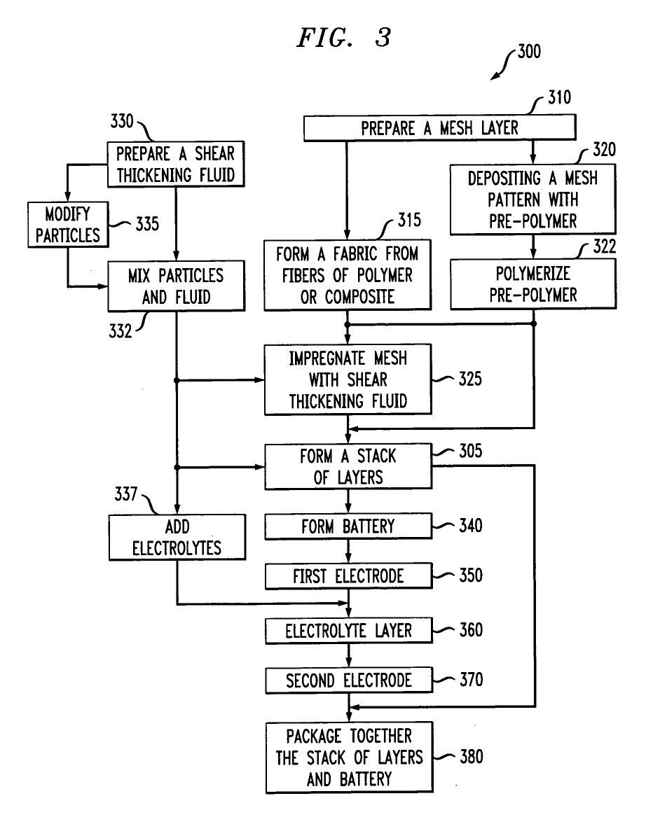

Another embodiment is a method of manufacturing an apparatus. Any of the embodiments of the apparatus discussed above in the context of FIGS. 1, 2A and 2B could be manufactured by the method. FIG. 3 presents a flow diagram showing selected steps in an exemplary method 300 of manufacturing an apparatus.

The method 300 comprises, in step 305, forming a stack of layers. As discussed in the context of FIG. 1, each of the layers having one or two surfaces that contact neighboring ones of the layers. At least one of the layers comprises a mesh layer. The stack of layers also comprises a shear thickening fluid. The shear thickening fluid is located within the mesh layer or in another layer of the stack of layers. In some cases the stack of layers 102 can be assembled manually, for instance by forming or depositing successive layers on top of each other. In other cases, the stack of layers 102 can be assembled using micromanipulators or other conventional automated instrumentation well known to those skilled in the art.

The method 300 can also include preparing a mesh layer in step 310. In some preferred embodiments, preparing the mesh layer comprises, a step 315, of weaving together fibers of a polymer or composite material such as described above in the context of FIGS. 1, 2A, and 2B, to form a fabric. In other preferred embodiments, preparing the mesh layer comprises, a step 320, of depositing a prepolymer to form the mesh pattern. In some cases, for example, an ink jet printer can be used to deposit the prepolymer in a predefined pattern corresponding to the mesh layer. The prepolymer can be polymerized in step 322 using, e.g., conventional forms of heat, light or chemical activation, either after or during the deposition of the prepolymer. In some cases, preparing the mesh layer can further comprise, a step 325, of impregnating the mesh layer with a shear thickening fluid. For instance, the mesh layer can be soaked until it is saturated with the shear thickening fluid.

The method 300 can also include a step 330 of preparing a shear thickening fluid. In some preferred embodiments, preparing the shear thickening fluid comprises a step 332 of mixing particles and a fluid together. In some cases, mixing is facilitated with the use of, e.g., milling or stirring equipment configured to mix the fluid and particles under low shear conditions. Mixing in this manner helps to disperse the particles uniformly throughout the fluid without initiating hardening. In some cases, before the mixing step 332, the particles are physically or chemically modified, in step 335, with a polymer, such as one or more of the hydrophobic polymers described above in the context of FIGS. 1 and 2. In still other cases, preparing the shear thickening fluid further comprises adding electrolyte to the shear thickening fluid in step 337. The electrolyte can be added by including a salt, acid, base or polymer electrolyte in the fluid either before, during or after mixing step 332. Alternatively, the fluid of the shear thickening fluid can be an ionic liquid.

Some embodiments of the method include a step 340 of forming a battery. In some cases, the battery is a conventional battery that is surrounded by the stack of layers, thereby affording protection from projectile penetration. In other cases, however, some of the layers of the stack comprise functional components of the battery. Forming the battery can comprise the steps of adding a first electrode, electrode layer, and second electrode in steps 350, 360 and 370, respectively. The first and second electrodes correspond to one or the other of a positive and negative electrode of the battery. In some cases the electrode layer is formed as part of forming the shear thickening fluid in steps 330, 332, 335 and 337. In such instances, the electrode layer can provide the dual functionalities of protecting against projectile penetration and serving as a battery electrolyte. In other instances, however, the electrode layer is formed independent of forming the shear thickening fluid. For example, the electrode layer can comprise a polymer electrolyte or an aqueous solution of salt, acid or base.

In some cases it is desirable to package the stack of layers and the battery together in step 380. For example, the outer surface of the apparatus can be covered with a material composed of polypropylene or polyethylene. Similar coverings can be used to facilitate containment of the shear thickening fluid or electrolyte layer with the stack of layers.

Although the embodiments have been described in detail, those of ordinary skill in the art should understand that they could make various changes, substitutions and alterations herein without departing from the scope of the invention.

What is claimed is:

1. An apparatus comprising:
a stack of layers, each of the layers having one or two surfaces that contact neighboring ones of the layers;
wherein at least one of the layers comprises a mesh layer, and a shear thickening fluid that is located within the mesh layer or in another layer of the stack of layers.

2. The apparatus of claim 1, wherein a plurality of the stack of layers comprise shear thickening fluid and the mesh layer.

3. The apparatus of claim 1, wherein the shear thickening fluid comprises nanoparticles having an average diameter that ranges from about 1 to about 1000 nanometers.

4. The apparatus of claim 1, wherein the shear thickening fluid comprises microparticles having an average diameter that ranges from about 1 to about 1000 microns.

5. The device of claim 1, wherein particles of the shear thickening fluid have an average diameter that is within about 20 percent of an average diameter of openings in the mesh layer.

6. The apparatus of claim 1, wherein the shear thickening fluid comprises a polymer.

7. The device of claim 1, wherein particles of the shear thickening fluid are physically or chemically modified with a polymer.

8. The device of claim 1, wherein particles of the shear thickening fluid are coated with a hydrophobic polymer.

9. The device of claim 1, wherein the mesh comprises a polymer or a composite material.

10. The apparatus of claim 1, wherein the shear thickening fluid is an electrolyte.

11. The apparatus of clam 1, further comprising a battery, the shear thickening fluid being an electrolyte of the battery.

12. The apparatus of claim 1, wherein the stack of layers further includes an electrolyte layer of a battery that is not shear thickening.

13. The device of claim 12, wherein the electrolyte layer includes one of a plurality of mesh layers.

14. The apparatus of claim 1, wherein the stack of layers further includes a negative electrode layer and a positive electrode layer of the battery.

15. The apparatus of claim 1, wherein the stack of layers is able to dissipate energy of a projectile contacting the stack of layers.

16. A method of manufacturing an apparatus, comprising forming a stack of layers, each of the layers having one or two surfaces that contact neighboring ones of the layers, wherein at least one of the layers comprises a mesh layer, and a shear thickening fluid that is located within the mesh layer or in another layer of the stack of layers.

17. The method of claim 16 further including, impregnating the mesh layer with the shear thickening fluid.

18. The method of claim 16 further including, forming the shear thickening fluid by mixing particles into a fluid, and coating the particles with a polymer.

19. The method of claim 18 further including, adding electrolytes to the fluid.

20. The method of claim 16 further including, forming a battery by adding positive and negative electrode layers to the stack of layers, each of the positive and negative electrode layers contacting one of the two surfaces of an electrolyte layer.
